(19) United States
(12) Patent Application Publication
(10) Pub. No.: US 2017/0288903 A1
(43) Pub. Date: Oct. 5, 2017

(54) CONTEXT DISCOVERY IN DATAPLANE PROGRAMMABILITY PROTOCOLS

(71) Applicant: Cisco Technology, Inc., San Jose, CA (US)

(72) Inventors: Sridhar Santhanam, Sunnyvale, CA (US); Andrew P. Thurber, Charlotte, VT (US)

(21) Appl. No.: 15/084,579

(22) Filed: Mar. 30, 2016

(51) Int. Cl. H04L 12/46; H04L 29/06

(52) U.S. Cl. CPC H04L 12/462; H04L 69/03; H04L 12/4641

(57) ABSTRACT

A method for discovering context using a dataplane programmability protocol. The method includes establishing communication with a network device via a dataplane programmability protocol, sending a context monitoring request, via the dataplane programmability protocol, to cause the network device to perform context monitoring, and in response to the context monitoring request, receiving a context update, via the dataplane programmability protocol, from the network device.

### TECHNICAL FIELD

Embodiments described herein relate to software defined networking, and particularly to a methodology to discover contexts within a network device via a dataplane programmability protocol.

### BACKGROUND

Software-defined networking (SDN) is an ever-developing architecture that is dynamic, manageable, cost-effective, and adaptable, and is suitable for the high-bandwidth, dynamic nature of today's applications. SDN architectures decouple network control and forwarding functions, enabling network control to become directly programmable and the underlying infrastructure to be abstracted from applications and network services.

OpenFlow is a protocol that enables SDN. Specifically, OpenFlow enables network controllers to determine the path of network packets across a network of switches or routers (or “network devices,” generally). The controllers are distinct from the network devices. This separation of the control from the forwarding operations allows for flexible and customized traffic management. Also, OpenFlow allows network devices from different vendors—often each with its own proprietary interface and scripting language—to be managed remotely using a single, open protocol.

Even more specifically, OpenFlow allows remote administration of, e.g., a layer 3 switch's packet forwarding tables, by adding, modifying and removing packet matching rules and actions. As such, routing decisions can be made periodically or ad hoc by the controller and translated into rules and actions with a configurable lifespan, which are then deployed to a switch's flow table, leaving the actual forwarding of matched packets to the switch at wire speed for the duration of those rules. Packets that are unmatched by the switch can be forwarded to the controller. The controller can then decide to modify existing flow table rules on one or more switches or to deploy new rules, to prevent a structural flow of traffic between switch and controller. The controller could even decide to forward the traffic itself.

### BRIEF DESCRIPTION OF THE DRAWINGS

FIG. 1 depicts a network topology including a controller and a target device for which contexts can be discovered according to an example embodiment.

FIG. 2 is a sequence diagram depicting operations for context discovery of all contexts within a network device according to an example embodiment.

FIG. 3 is a sequence diagram depicting operations for context discovery of all VLAN contexts within a network device according to an example embodiment.

FIG. 4 is a sequence diagram depicting operations for context discovery of specific VLAN contexts within a network device according to an example embodiment.

FIG. 5 is a sequence diagram depicting operations for avoiding flow programming errors when context information does not exist in a network device according to an example embodiment.

FIG. 6 depicts an apparatus that is configured to operate as a controller or a network device for performing context discovery according to an example embodiment.

### DESCRIPTION OF EXAMPLE EMBODIMENTS

### Overview

In accordance with embodiments described herein there is provided a method for discovering context using a Dataplane Programmability Protocol. The method includes establishing communication with a network device via a Dataplane Programmability Protocol, sending a context monitoring request, via the Dataplane Programmability Protocol, to cause the network device to perform context monitoring, and in response to the context monitoring request, receiving a context update, via the Dataplane Programmability Protocol, from the network device.

In accordance with another embodiment described herein a method includes establishing communication with a software defined networking (SDN) Controller via a Dataplane Programmability Protocol, receiving a context monitoring request, via the Dataplane Programmability Protocol, and in response to the context monitoring request, sending a context update, via the Dataplane Programmability Protocol, to the SDN Controller.

### Example Embodiments

As explained above, in the context of SDN, OpenFlow allows remote administration of, e.g., a layer 3 switch's packet forwarding tables, by adding, modifying and removing packet matching rules and actions. As such, routing decisions can be made periodically or ad hoc by a controller and translated into rules and actions with a configurable lifespan, which are then deployed to a switch's flow table, leaving the actual forwarding of matched packets to the switch at wire speed for the duration of those rules. Packets that are unmatched by the switch can be forwarded to the controller. The controller can then decide to modify existing flow table rules on one or more switches or to deploy new rules, to prevent a structural flow of traffic between switch and controller. The controller can even decide to forward the traffic itself.

OpenFlow is one SDN enabling protocol. P4 is another similar protocol that has been employed to implement SDN. In the context of this description, each of those protocols, and like protocols, may be referred to more generically as a “Dataplane Programmability Protocol,” or “DPP,” in that the protocol enables the programming of the rules and forwarding tables that are responsible for determining how to switch or route packets in the dataplane.

Significantly, with DPPs, there is no in-band method for a network or target device (e.g., a switch, router, firewall, etc.) to inform a connected controller about restrictions on packet visibility and control for the exposed forwarding plane. That is, in the use of DPPs in an SDN infrastructure, as assumption is made: either it is expected that the forwarding plane allows controller visibility into all packets that traverse the target device, or the discovery of a more limited forwarding “context” for packets is handled outside of the DPP. Examples of target device context include, but are not limited to:

Bridge domains;

Virtual Extensible Local Area Network (VXLAN) topologies;

Subset of Virtual LAN (VLAN) IDs or Multiprotocol Label Switching (MPLS) labels;

Internet Protocol (IP) subnets; and

Virtual Routing and Forwarding (VRF) or Virtual Forwarding Instance (VFI) information.

The embodiments described herein provide a generic mechanism for DPP context information exchange. In a particular implementation, the embodiments described herein provide VXLAN Network Identifier (VNI) topology information between an OpenFlow Agent running on a Cisco (San Jose, Calif.) Nexus 9K router (the target or network device) and an SDN controller.

More specifically, the described embodiments provide a generic mechanism for controllers to express their desire to discover available context and a mechanism for a target device to notify controllers about context as changes occur, all via a DPP.

In accordance with an embodiment, after an initial DPP handshake, a controller sends an optional context monitoring request. Specific context types may be provided, along with details of context IDs of interest or a request for notification about all contexts of the specified type. Monitoring requests may indicate interest in current context information, future context changes, or both.

In response to an initial request the network device schedules, possibly immediately, an asynchronous response with current context information.

Thereafter, the network device may monitor local changes in context, and supplies that information to the requesting SDN controller, via a DPP. Configuration, local control plane, software or hardware changes are examples of the type of events that may cause context changes. When a change event occurs and a controller has previously expressed interest in receiving context updates, then an asynchronous update may be sent to the controller via the DPP. Periodic, scheduled updates may alternatively be implemented.

In accordance with an embodiment, not all controllers need to register for notifications, and different controllers can request different notification sets.

As one example, changes made via command line interface (CLI) to a network device can affect the VLAN/VNI context of the network device. This context information can now be supplied back to a controller, via a DPP, such as OpenFlow.

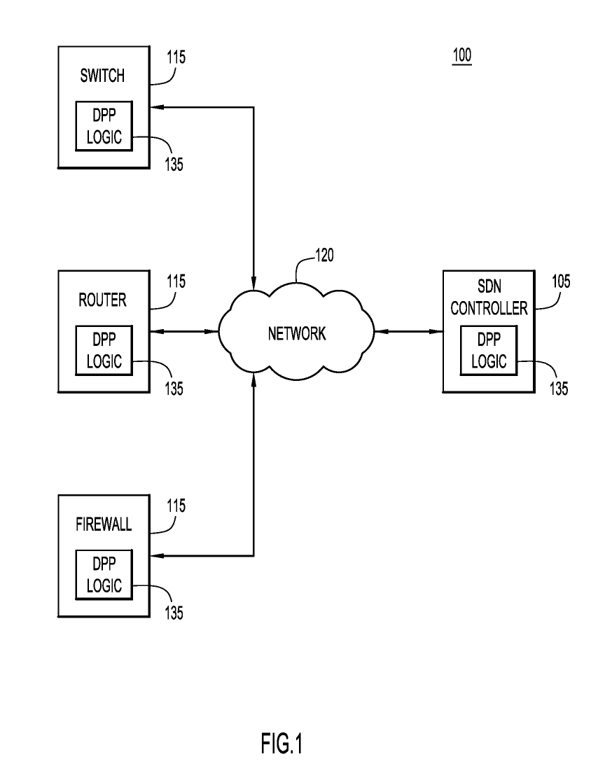

Reference is now made to FIG. 1, which shows a system 100 in which an SDN controller 105 may communicate with network (or target) devices 115 over network 120. Such network devices 115 may be any one of, e.g., a switch, a router or a firewall, among other possible network devices. SDN controller 105 may operate from a physical computing device or from a virtual or cloud-based computing resource. An administrator using SDN controller 105 can change any target device packet forwarding rules using DPP logic 135 resident on both SDN controller and network devices 115 using, e.g., an associated application programming interface (API) call.

Those skilled in the art will appreciate that it is possible for a network device 115 to be programmed outside of a DPP. That is, an administrator can access network device 115 and make “context” changes thereto without an SDN controller having knowledge of such changes. It is because of this scenario that the embodiments described herein can be particularly useful in that an SDN controller can now discover, via a DPP, the contexts within a network device.

Such information can be helpful for a number of reasons. For example, if an SDN controller assumes it has full control over all packets passing through a given network device, the SDN controller might try to solve a networking problem that the controller, by virtue of not having complete control, cannot solve, potentially leading to increased networking problems. Additionally, by an SDN controller trying to control certain parameters of a network device without authority to do so, multiple error messages can be generated, still further causing unnecessary network traffic.

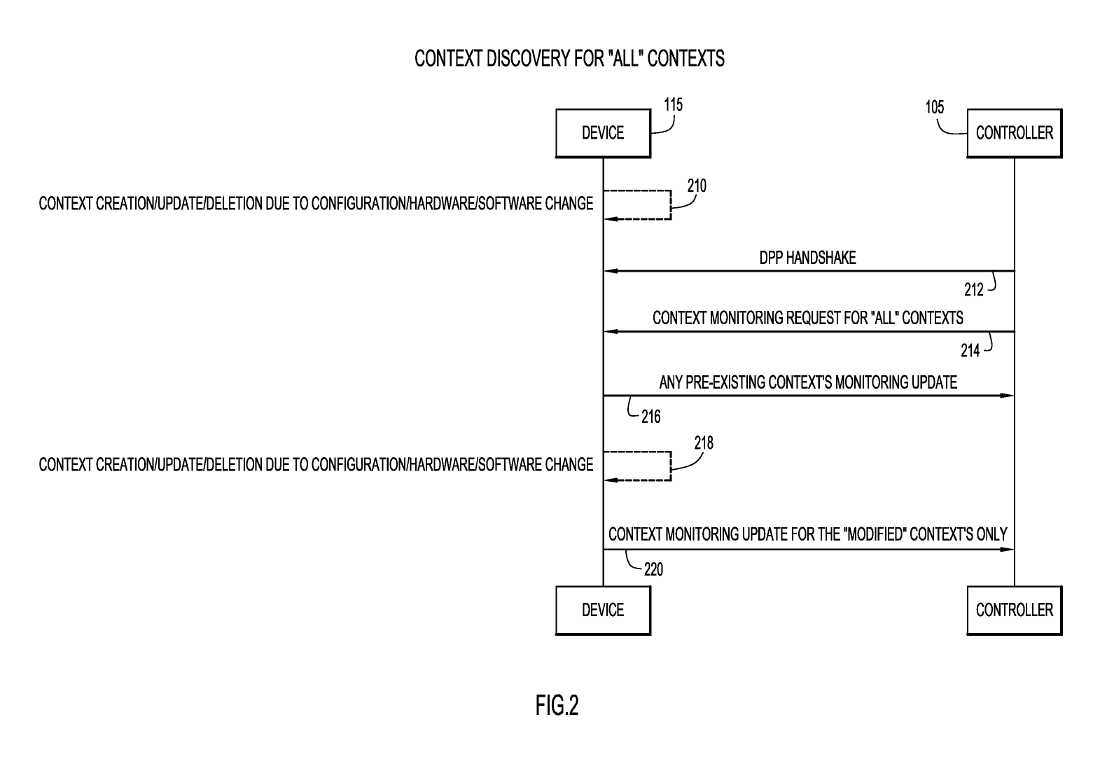

Reference is now made to FIGS. 2-5 which depict functionality or operations that can be embodied in instructions or logic that is made part of DPP logic 135.

FIG. 2 is a sequence diagram depicting operations for context discovery of “all” contexts of a network device according to an example embodiment. As shown, at 210, context creation, update or deletion occurs in network device 115 as a result of a configuration, hardware or software change. Such a change, as noted, may be unknown to SDN controller 105. At 212, a DPP handshake is performed to establish a communication path via the DPP between device 115 and SDN controller 105. It is noted that DPP handshake 212 may be performed before change 210 occurs on network device 115. At 214, SDN controller 105 sends, via the DPP, a context monitoring request for “all” contexts. In essence, this request 214 asks network device 115 for any information it holds that defines its context.

At 216, network device 115 sends any pre-existing context monitoring update information to SDN controller 105. That is, since network device 115 is configured to be responsive to a context monitoring request, network device 115 may likewise be configured to store context changes even before a request for such context is received. In this way, as soon as request 214 is received at network device 115, network device 115 can immediately respond with context monitoring update 216.

Thereafter, at 218, device 115 may undergo yet another context change via creation, update or deletion of a context as a result of a configuration, hardware or software change.

Responsive to the change in operation 218, at 220, network device 115 sends a context monitoring update, and in accordance with one possible implementation, for only the modified contexts. However, all contexts could similarly be supplied to SDN controller 105.

Thus, as can be understood from the series of operations shown in FIG. 2, context of a given network device 115 can be discovered by SDN controller 105 using a DPP.

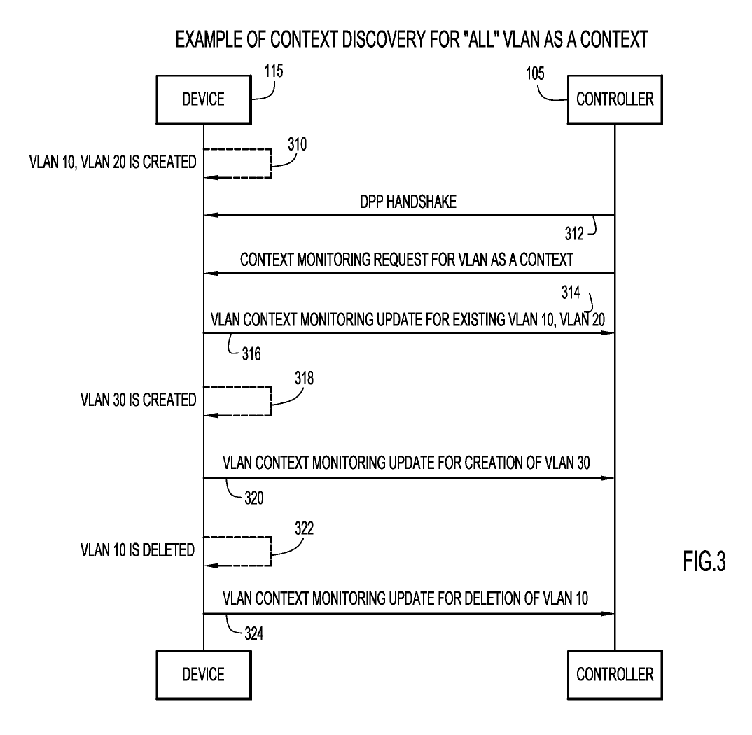

FIG. 3 is a sequence diagram depicting operations for context discovery of “all VLAN” contexts of a network device according to an example embodiment. As shown, at 310, two VLANs are created: vlan 10 and vlan 20. Such a change, as noted, may be unknown to SDN controller 105. At 312, a DPP handshake is performed to establish a communication path via the DPP between device 115 and SDN controller 105. It is noted that DPP handshake 312 may be performed before vlans 10 and 20 are created. At 314, SDN controller 105 sends, via the DPP, a context monitoring request limited to “VLANs”. In essence, this request 314 asks network device 115 for any information it holds related to VLAN context.

At 316, network device 115 sends to SDN controller 105 pre-existing context information related to vlan 10 and vlan 20, consistent with how those two VLANs are presently configured to be processed by network device 115. That is, since network device 115 is configured to be responsive to a context monitoring request, network device 115 may likewise be configured to store context changes even before a request for such context is received. In this way, as soon as request 314 is received at network device 115, network device 115 can immediately respond with context monitoring update 316.

Thereafter, at 318, network device 115 may be configured to handle or process packets associated with vlan 30, or may be configured to allow SDN Controller 105 to control, handle or process packets associated with vlan 30.

Responsive to the change in 318, at 320, network device 115 sends a context monitoring update in connection with vlan 30 to notify controller 105 of the new context.

Thereafter, at 322, vlan 10 is deleted such that network device 115 no longer handles or processes packets associated with vlan 10, or no longer allows SDN Controller 105 to control, handle or process packets associated with vlan 10. This information is provided to SDN controller 105 via operation 324.

Thus, as can be understood from the series of operations, VLAN context of a given network device 115 can be discovered by SDN controller 105 using a DPP in real time such that SDN controller 105 need not needlessly attempt to supply rules or flow tables for packets over which the controller does not have control.

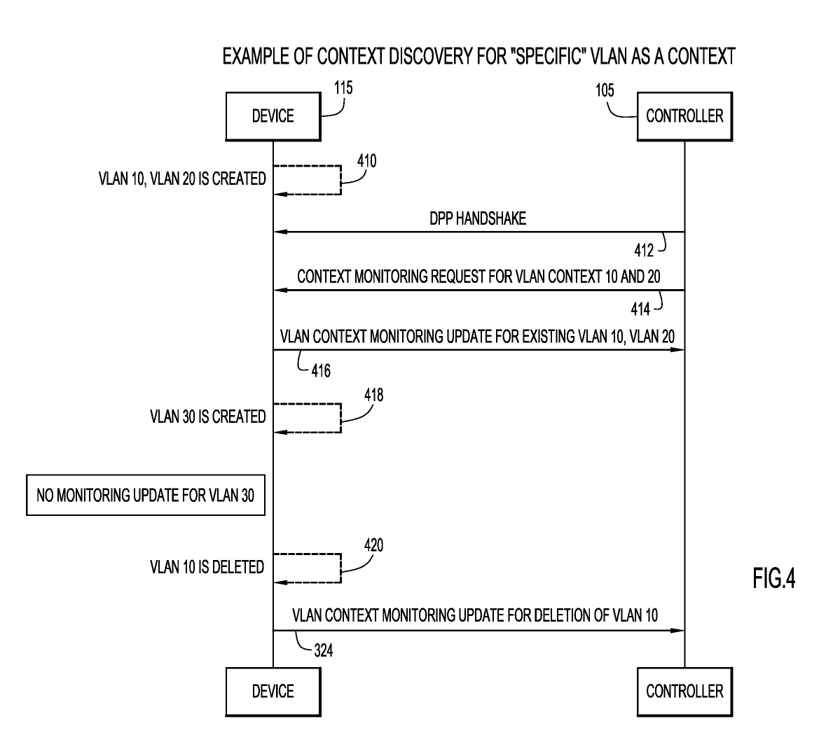

FIG. 4 is a sequence diagram depicting operations for context discovery of “specific VLAN” contexts of a network device according to an example embodiment. As shown, at 410, two VLANs are created: vlan 10 and vlan 20. Such a change, as noted, may be unknown to SDN controller 105. At 412, a DPP handshake is performed to establish a communication path via the DPP between device 115 and SDN controller 105. It is noted that DPP handshake 412 may be performed before vlans 10 and 20 are created. At 414, SDN controller 105 sends, via the DPP, a context monitoring request limited to context for “VLANs 10 and 20”. In essence, this request 414 asks network device 115 for information it holds related to VLAN 10 and 20 context.

At 416, network device 115 sends to SDN controller 105 a VLAN context monitoring update for existing vlan 10 and vlan 20, consistent with how those two VLANs are presently configured to be processed by network device 115. That is, since network device 115 is configured to be responsive to a context monitoring request, network device 115 may likewise be configured to store context changes even before a request for such context is received. In this way, as soon as request 414 is received at network device 115, network device 115 can immediately respond with context monitoring update 416.

Thereafter, at 418, network device 115 may be configured to handle or process packets associated with a new vlan 30, or may be configured to allow SDN Controller 105 to control, handle or process packets associated with vlan 30. However, vlan 30 was not part of the request for “specific vlan” context. As such, and as indicated in FIG. 4, no monitoring update is provided in connection with the creation of vlan 30.

At 420, vlan 10 is deleted such that network device 115 no longer handles or processes packets associated with vlan 10, or no longer allows SDN Controller 105 to control, handle or process packets associated with vlan 10. This information is provided to SDN controller 105 via operation 422.

Thus, as can be understood from the series of operations of FIG. 4, specific VLAN context of a given network device 115 can be discovered by SDN controller 105 using a DPP in real time such that SDN controller 105 need not needlessly attempt to supply rules or flow tables for packets over which the controller does not have control.

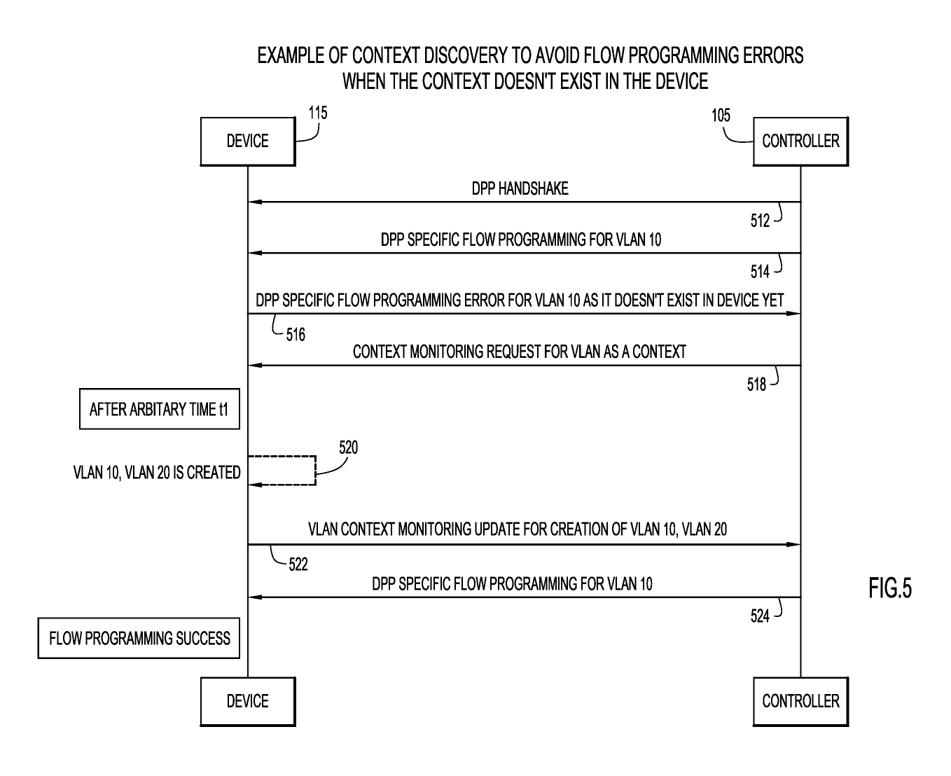

FIG. 5 is a sequence diagram depicting operations for avoiding flow programming errors when context information does not exist in a network device according to an example embodiment. As shown, at 512, a DPP handshake is performed to establish a communication path via the DPP between device 115 and SDN controller 105. At 514, SDN controller 105 sends, via the DPP, specific flow programming for vlan 10. At 516, network device 115 returns a DPP specific flow programming error for vlan 10 as vlan 10 does not yet exist in network device 115, or SDN Controller 105 has not been granted control for vlan 10 at network device 115.

At 518, SDN controller 105 sends a context monitoring request for “VLANs”. In essence, this request 518 asks network device 115 for any information it holds related to VLAN contexts.

After some arbitrary amount of time, at 520, vlan 10 and vlan 20 are created. At 522, network device 115 sends to SDN controller 105 a VLAN context monitoring update for newly-created vlan 10 and vlan 20, consistent with how those two VLANs are presently configured to be processed by network device 115. Once SDN controller 105 discovers the creation of vlan 10, SDN controller, at 524, sends the same (or a different) DPP specific flow programming for vlan 10, resulting in successful flow programming. Notably, by receiving the prior error message at 516, SDN controller ceases to attempt to provide flow programming for vlan 10, thereby resulting in fewer error messages being generated.

Thus, as can be understood from the series of operations of FIG. 5, an error message received in the course of DPP communication can be used to trigger a context monitoring request to be sent to a network device, also communicated via DPP. This can help to reduce traffic in the control plane of the network by avoiding repeated flow programming errors.

Although FIG. 5 depicts only a single flow programming error that triggers the context monitoring request, the embodiments described herein can also be implemented such that SDN controller 105 sends a context monitoring request, via a DPP, after a threshold number of error messages have been received. That is, there may be other reasons why a flow programming error occurred besides the possibility of the SDN controller not having control over a given network device context.

In one implementation, the several messages depicted in FIGS. 2-5 may be implemented by defining new OpenFlow message types. In this way, if an SDN controller sends such a new message type to a given network device, and that network device does not recognize the message type, the network device may simply respond with an error message. Such information is also useful to know from the perspective of the SDN controller as it informs the SDN controller of whether context information can be gleaned from a given network device.

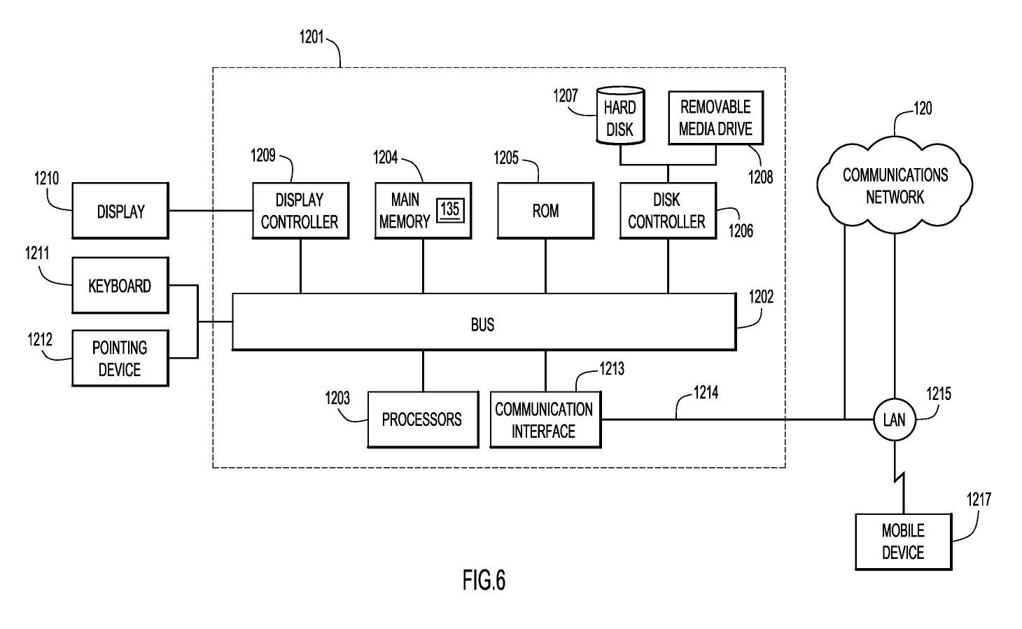

FIG. 6 depicts an apparatus that is configured to operate as an SDN controller 105 or a network device 115 for performing context discovery according to an example embodiment. The devices may be implemented on a computer system 1201. The computer system 1201 may be programmed to implement a computer based device. The computer system 1201 includes a bus 1202 or other communication mechanism for communicating information, and a processor 1203 coupled with the bus 1202 for processing the information. While the figure shows a signal block 1203 for a processor, it should be understood that the processors 1203 represent a plurality of processing cores, each of which can perform separate processing. The computer system 1201 also includes a main memory 1204, such as a random access memory (RAM) or other dynamic storage device (e.g., dynamic RAM (DRAM), static RAM (SRAM), and synchronous DRAM (SD RAM)), coupled to the bus 1202 for storing information and instructions to be executed by processor 1203. In addition, the main memory 1204 may be used for storing temporary variables or other intermediate information during the execution of instructions by the processor 1203. Main memory may also be sued to store logic instructions or software for DPP logic 135.

The computer system 1201 may further include a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 may also include a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 1201 may also include a display controller 1209 coupled to the bus 1202 to control a display 1210, such as a cathode ray tube (CRT) or liquid crystal display (LCD), for displaying information to a computer user. The computer system 1201 may include input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing operations of the embodiments described herein in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 (like 120 in FIG. 1) such as the Internet. For example, the communication interface 1213 may be a wired or wireless network interface card to attach to any packet switched (wired or wireless) LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local are network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Thus, in accordance with the embodiments described herein, there is provided a method including establishing communication with a network device via a dataplane programmability protocol, sending a context monitoring request, via the dataplane programmability protocol, to cause the network device to perform context monitoring; and in response to the context monitoring request, receiving a context update, via the dataplane programmability protocol, from the network device.

In the method the dataplane programmability protocol may be OpenFlow.

In the method of claim the context monitoring request may be a request for all contexts.

In the method the context monitoring request may be a request for a predetermined type of context.

In the method the predetermined type of context comprises at least one of bridge domains, Virtual Extensible Local Area Network (VXLAN) topologies, Virtual Local Area Network (VLAN) ID, Virtual LAN (VLAN) ID subset, Multiprotocol Label Switching (MPLS) labels, Internet Protocol (IP) subnets, Virtual Routing and Forwarding (VRF) information, or Virtual Forwarding Instance (VFI) information.

The method may further include receiving a subsequent context update upon a change in context of the network device.

The method may still further include receiving an error message from the network device in response to the context monitoring request.

The method may still further include sending a dataplane programmability protocol specific flow programming command to the network device, receiving a dataplane programmability protocol specific flow programming error responsive to the dataplane programmability protocol specific flow programming command, sending another context monitoring request, via the dataplane programmability protocol, to cause the network device to perform context monitoring of a context associated with the dataplane programmability protocol specific flow programming command, in response to the another context monitoring request, receiving another context update, via the dataplane programmability protocol, from the network device, and resending the dataplane programmability protocol specific flow programming command to the network device.

In the method the dataplane programmability protocol specific flow programming command may be to program processing of packets associated with a predetermined virtual local area network (VLAN).

In another embodiment, a method includes establishing communication with a software defined networking (SDN) Controller via a dataplane programmability protocol, receiving a context monitoring request, via the dataplane programmability protocol, and in response to the context monitoring request, sending a context update, via the dataplane programmability protocol, to the SDN Controller.

In the method of the another embodiment the dataplane programmability protocol may be OpenFlow.

In the method of the another embodiment the context monitoring request may be a request for all contexts.

In the method of the another embodiment the context monitoring request may be a request for a predetermined type of context.

In the method of the another embodiment the type of context comprises at least one of bridge domains, Virtual Extensible Local Area Network (VXLAN) topologies, Virtual Local Area Network (VLAN) ID, Virtual LAN (VLAN) ID subset, Multiprotocol Label Switching (MPLS) labels, Internet Protocol (IP) subnets, Virtual Routing and Forwarding (VRF) information, or Virtual Forwarding Instance (VFI) information.

The method of the another embodiment further includes sending a subsequent context update upon a change in context.

The method of the another embodiment further includes receiving a dataplane programmability protocol specific flow programming command from the SDN Controller, sending a dataplane programmability protocol specific flow programming error responsive to the dataplane programmability protocol specific flow programming command, receiving another context monitoring request, via the dataplane programmability protocol, in response to the another context monitoring request, sending another context update, via the dataplane programmability protocol, to the SDN Controller, and receiving, again, the dataplane programmability protocol specific flow programming command to the network device.

Also provided is one or more computer readable non-transitory storage media encoded with software comprising computer executable instructions that, when executed, are operable to establish communication with a network device via a dataplane programmability protocol, send a context monitoring request, via the dataplane programmability protocol, to cause the network device to perform context monitoring, and in response to the context monitoring request, receive a context update, via the dataplane programmability protocol, from the network device.

The above description is intended by way of example only. Various modifications and structural changes may be made therein without departing from the scope of the concepts described herein and within the scope and range of equivalents of the claims.

What is claimed is:

1. A method comprising:
establishing communication with a network device via a dataplane programmability protocol;
sending a context monitoring request, via the dataplane programmability protocol, to cause the network device to perform context monitoring; and
in response to the context monitoring request, receiving a context update, via the dataplane programmability protocol, from the network device.

2. The method of claim 1, wherein the dataplane programmability protocol is OpenFlow.

3. The method of claim 1, wherein the context monitoring request is a request for all contexts.

4. The method of claim 1, wherein the context monitoring request is a request for a predetermined type of context.

5. The method of claim 4, wherein the predetermined type of context comprises at least one of bridge domains, Virtual Extensible Local Area Network (VXLAN) topologies, Virtual Local Area Network (VLAN) ID, Virtual LAN (VLAN) ID subset, Multiprotocol Label Switching (MPLS) labels, Internet Protocol (IP) subnets, Virtual Routing and Forwarding (VRF) information, or Virtual Forwarding Instance (VFI) information.

6. The method of claim 1, further comprising receiving a subsequent context update upon a change in context of the network device.

7. The method of claim 1, further comprising receiving an error message from the network device in response to the context monitoring request.

8. The method of claim 1, further comprising:
sending a dataplane programmability protocol specific flow programming command to the network device;
receiving a dataplane programmability protocol specific flow programming error responsive to the dataplane programmability protocol specific flow programming command;
sending another context monitoring request, via the dataplane programmability protocol, to cause the network device to perform context monitoring of a context associated with the dataplane programmability protocol specific flow programming command;
in response to the another context monitoring request, receiving another context update, via the dataplane programmability protocol, from the network device; and
resending the dataplane programmability protocol specific flow programming command to the network device.

9. The method of claim 8, wherein the dataplane programmability protocol specific flow programming command is to program processing of packets associated with a predetermined virtual local area network (VLAN).

10. A method comprising:
establishing communication with a software defined networking (SDN) Controller via a dataplane programmability protocol;
receiving a context monitoring request, via the dataplane programmability protocol; and
in response to the context monitoring request, sending a context update, via the dataplane programmability protocol, to the SDN Controller.

11. The method of claim 10, wherein the dataplane programmability protocol is OpenFlow.

12. The method of claim 10, wherein the context monitoring request is a request for all contexts.

13. The method of claim 10, wherein the context monitoring request is a request for a predetermined type of context.

14. The method of claim 13, wherein the type of context comprises at least one of bridge domains, Virtual Extensible Local Area Network (VXLAN) topologies, Virtual Local Area Network (VLAN) ID, Virtual LAN (VLAN) ID subset, Multiprotocol Label Switching (MPLS) labels, Internet Protocol (IP) subnets, Virtual Routing and Forwarding (VRF) information, or Virtual Forwarding Instance (VFI) information.

15. The method of claim 10, further comprising sending a subsequent context update upon a change in context.

16. The method of claim 10, further comprising:
receiving a dataplane programmability protocol specific flow programming command from the SDN Controller;
sending a dataplane programmability protocol specific flow programming error responsive to the dataplane programmability protocol specific flow programming command;
receiving another context monitoring request, via the dataplane programmability protocol;
in response to the another context monitoring request, sending another context update, via the dataplane programmability protocol, to the SDN Controller; and
receiving, again, the dataplane programmability protocol specific flow programming command to the network device.

17. One or more computer readable non-transitory storage media encoded with software comprising computer executable instructions that, when executed, are operable to:
establish communication with a network device via a dataplane programmability protocol;
send a context monitoring request, via the dataplane programmability protocol, to cause the network device to perform context monitoring; and
in response to the context monitoring request, receive a context update, via the dataplane programmability protocol, from the network device.

18. The computer readable storage media of claim 17, wherein the dataplane programmability protocol is OpenFlow.

19. The computer readable storage media of claim 17, wherein the context monitoring request is a request for all contexts.

20. The computer readable storage media of claim 17, wherein the context monitoring request is a request for a predetermined type of context comprising at least one of bridge domains, Virtual Extensible Local Area Network (VXLAN) topologies, Virtual Local Area Network (VLAN) ID, Virtual LAN (VLAN) ID subset, Multiprotocol Label Switching (MPLS) labels, Internet Protocol (IP) subnets, Virtual Routing and Forwarding (VRF) information, or Virtual Forwarding Instance (VFI) information.
